(19) United States
(12) Patent Application Publication
(10) Pub. No.: US 2023/0298553 A1
(43) Pub. Date: Sep. 21, 2023

(54) Acoustic Meta Material Panel System for Attenuating Sound

(71) Applicant: SMD Corporation, Manassas, VA (US)

(72) Inventors: Curtis R. Mitchell, Gainesville, VA (US); Christopher Robert Fuller, Virginia Beach, VA (US)

(21) Appl. No.: 18/042,215

(22) PCT Filed: Aug. 19, 2021
(86) PCT No.: PCT/US2021/071235

§ 371 Date: Feb. 19, 2023

Related U.S. Application Data
(60) Provisional application No. 63/067,322, filed on Aug. 19, 2020.

(51) Int. Cl. G10K 11/168; G10K 11/165; G10K 11/172

(52) U.S. Cl. CPC G10K 11/168; G10K 11/165; G10K 11/172

(57) ABSTRACT

An acoustic material system (12) has a matrix of material (14) supporting a plurality of evenly spaced and non-evenly spaced wave scatterer elements (16 and 18) of different density. The matrix (14) may consist of poro-elastic materials. The wave scattering elements (16 and 18) may consist of masses of different shapes and sizes. Microporous sheets may be utilized in layers between matrices (14). The holes (32) formed in the sheets (28) may be of different sizes, shapes, and may have three-dimensional profile, such as a conical shape (50).

### RELATED APPLICATIONS

This application claims the benefit of U.S. Provisional Application Ser. No. 63/067,322 entitled “ACOUSTIC META MATERIAL PANEL SYSTEM FOR ATTENUATING SOUND” filed on 19 Aug. 2020, the contents of which are incorporated herein by reference in its entirety.

### COPYRIGHT NOTICE

A portion of the disclosure of this patent document may contain material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### BACKGROUND OF THE INVENTION

The field of the invention is in the reduction of noise. The use of micro-perforated plates with absorbent layers and air gaps evenly distributed. Also, the use of sound insulation with sandwich element, insulation are also known in which holes and open space elements are evenly dispersed within the features.

US Patent No. 9390705B2 by Mathur teaches an acoustic metamaterial that is layered composite for noise control which may have micro-perforated plates alternately and periodically spaced arranged with a plurality of absorbent layers and optional air gaps (each evenly distributed).

US Patent No. 8499887B2 issued to Gleine et al. teaches an acoustically optimized cabin wall element for sound insulation with sandwich element, insulation package, and absorber plane element in which the acoustic material is bagged and touching the microporous sheets and all holes and open space elements are substantially evenly dispersed.

### SUMMARY OF THE INVENTION

The present invention is an acoustic material system (12) which has a matrix of material (14) supporting a plurality of evenly spaced and non-evenly spaced wave scatterer elements (16 and 18) of different density. The present invention further uses microperforated acoustic metamaterials or microporous sheets (28) to reduce noise.

The matrix (14) may consist of poro-elastic materials. The wave scatterer elements (16 and 18) may consist of masses (22) of different shapes (24) and sizes (26).

The microporous sheets (28) may be utilized in layers between matrices (14) and in curved and circular shapes. The holes (32) formed in the sheets (28) may be of different sizes, shapes (34), distributions, and may have three-dimensional profile, such as a conical shape (50).

An advantage of the present design is greater noise dampening with less material and reduction in surface friction drag (w) over the surface of the material.

Another advantage is that these acoustic curtain systems (10) has a range of industrial applications including but not limited to bunks, automobiles, aircraft, RV’s, boats, hospitals, doctor’s offices, bedrooms, factory working areas and gymnasiums.

These and other aspects of the present invention will become readily apparent upon further review of the following drawings and specification.

### BRIEF DESCRIPTION OF THE DRAWINGS

The novel features of the described embodiments are specifically set forth in the appended claims; however, embodiments relating to the structure and process of making the present invention, may best be understood with reference to the following description and accompanying drawings.

FIG. 1 shows a cutaway side view of a single layer of an acoustic material system (12) according to an embodiment of the present design.

FIG. 2 shows a cutaway side view of a multi-layer of an acoustic material system (12) according to an embodiment of the present design.

FIG. 3 shows a top (or plan) view of a microporous sheet (28) with holes (32) evenly dispersed therethrough.

FIG. 4 shows a cutaway side view of a multi-layer of an acoustic material system (12) according to an embodiment of the present design with matrix (14) with evenly spaced and non-evenly spaced located scatterer elements (16 and 18) of different densities.

FIG. 5 shows an elevated environmental view of a microporous sheet (28) on a box (60) in showing edge sealing (62).

FIG. 6 is a side cutaway view of an acoustic material system (12) according to an embodiment of the present design including Holmholtz resonators (58) dispersed in the matrix (14).

FIG. 7 is a cutaway side view of a box (60) containing an acoustic material system (12) showing the edge sealing (62) and demonstrating that the microporous sheet (28) acoustically sealed (62) at the edge (64).

FIG. 8 is a diagram of a side view of a microporous sheet (28) demonstrating a conical indentation (50) in the sheet (28) created by a punch tool (t) forming a non-flat surface.

FIG. 9 is a diagram depicting an experimental set up to measure the noise reduction of an acoustic curtain system (10) acoustic material system (12) according to various embodiments of the present design.

FIGS. 10 and 11 show plan views, each with a corner blow up, demonstrating alternative microporous sheet (28) hole (32) designs and random distribution according to exemplary embodiments.

Similar reference characters denote corresponding features consistently throughout the attached drawings.

### DETAILED DESCRIPTION OF PREFERRED EMBODIMENTS

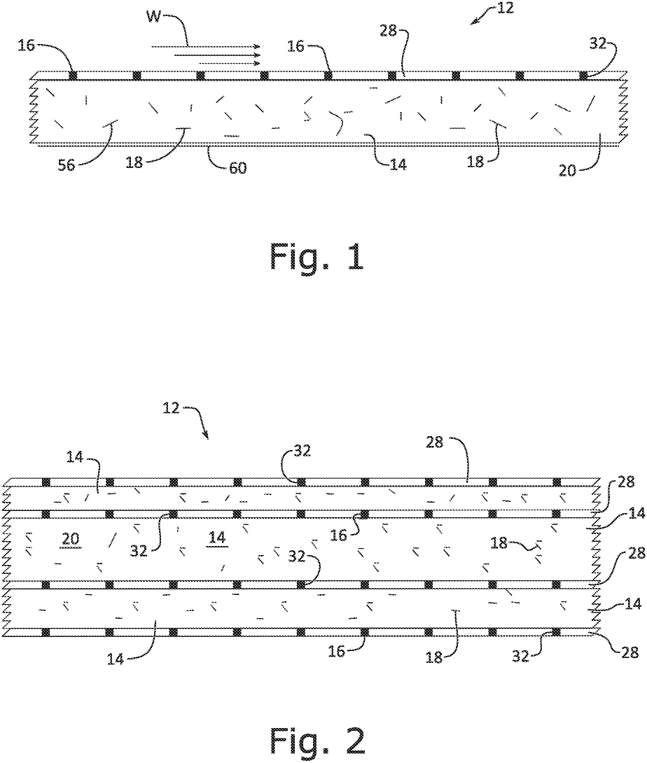

An acoustic material system (12) for attenuating sound has wave scattering elements (16) and (18) which effect the flow of sound waves (w). FIG. 1 shows a cutaway side view of a single layer of an acoustic material system (12) according to an embodiment of the present design. FIG. 2 shows a multi-layer embodiment of the acoustic material system (12) from the side. The acoustic material system (12) has a matrix of material (14) supporting a plurality of evenly spaced wave scattering elements (16) and non-evenly spaced wave scattering elements (18) of any size, shape, weight, and material. The plurality of evenly spaced wave scattering elements (16) and non-evenly spaced wave scattering elements (18) may have different density. The matrix material (14) shown in FIGS. 1 and 2 may consist of poroelastic material (20) or of other materials.

The wave scattering elements (16 and 18) consist of masses (22) of different shapes (24) and sizes (26) incorporated into the matrix material (14). The wave scatterer elements (16 and 18) may also consist of voids (52) in the matrix material (14) of different shapes (24) and sizes (26) including spheres (54) and thin surfaces (56). The masses (22) of different shapes (24) and sizes (26) include Helmholtz resonators (58), shown in FIG. 6. The wave scatterer elements (16 and 18) consist of masses (22) of different shapes (24) and sizes (26), as shown in FIGS. 4 and 6.

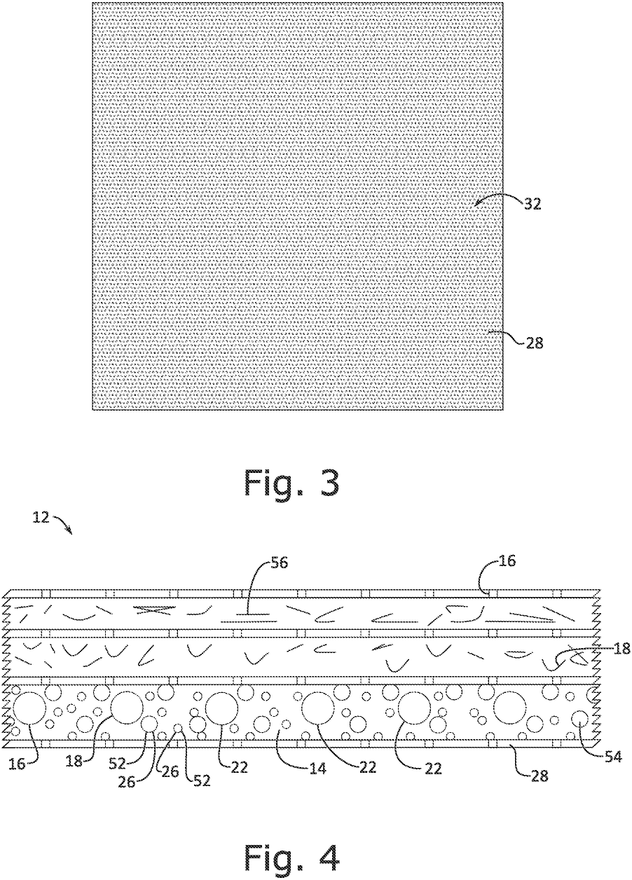

The wave scattering elements (16 and 18) may also consist of thin sheets (28) with micro holes (32) of different shapes (34) and sizes (36) and thickness (38). The thin sheets (28) may have various polymer and metal materials (30). FIG. 3 shows a top (or plan) view of a thin microporous sheet (28) with micro holes (32) evenly dispersed therethrough. The micro holes (32) may have a randomized non-periodic hole pattern (40) and hole size (36). The hole shape (34) may be any circular (42), elliptical (44), rectangular (46), polyhedral (48), volcano punch (conical) (50) shape, or essentially randomized combinations thereof.

The various polymer and metal materials utilized may be taken from the group including metalized microporous sheets, carbon fiber microporous sheets, fiberglass microporous sheets, polycarbonate sheets, and combinations thereof. Polycarbonate is used in molding materials and films, and is a synthetic resin composed of polymer units linked through carbonate groups. The sheets can be flat, non-flat, spherical, or section only or combinations thereof.

FIG. 4 shows a cutaway side view of a multi-layer of an acoustic material system (12) according to an embodiment of the present design with matrix (14) with evenly spaced and non-evenly spaced located scatterer elements (16 and 18) of different densities. Furthermore, the matrix (14) may incorporate embedded cavities (52) in a foam.

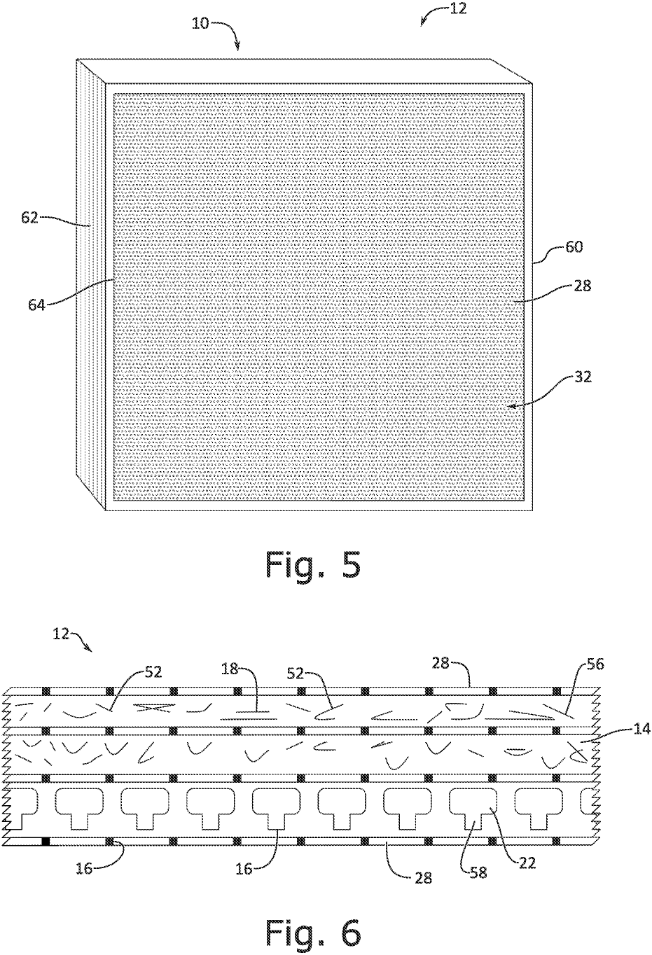

The microporous sheet (28) incorporates edge sealing (62) techniques to reduce/eliminate leakage on the edge assembly (64) as shown in FIG. 5. FIG. 5 shows an elevated environmental view of a microporous sheet (28) on a box (60) in showing edge sealing (62). Tape, sew, glue, extrusion, and frames are used as a seal (62).

Helmholtz resonators (58) act as band pass filters. FIG. 6 is a side cutaway view of an acoustic material system (12) according to an embodiment of the present design including Holmholtz resonators (58) dispersed in the matrix (14).

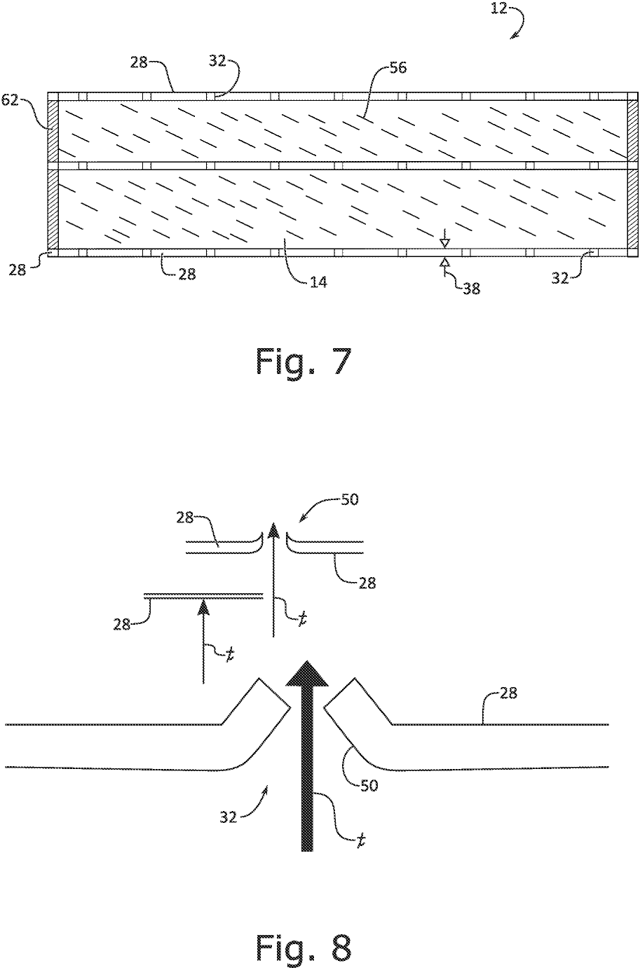

FIG. 7 is a cutaway side view of a box (60) containing an acoustic material system (12) showing the edge sealing (62) and demonstrating that the microporous sheet (28) acoustically sealed (62) at the edge (64).

FIG. 8 is a diagram of a side view of a microporous sheet (28) demonstrating a conical indentation (50) in the sheet (28) created by a punch tool (t) forming a non-flat surface. The conical indentation (50) can be punched from either or both sides of the sheet (28), and the conical shaped holes (50) may be evenly spaced or non-evenly spaced or both.

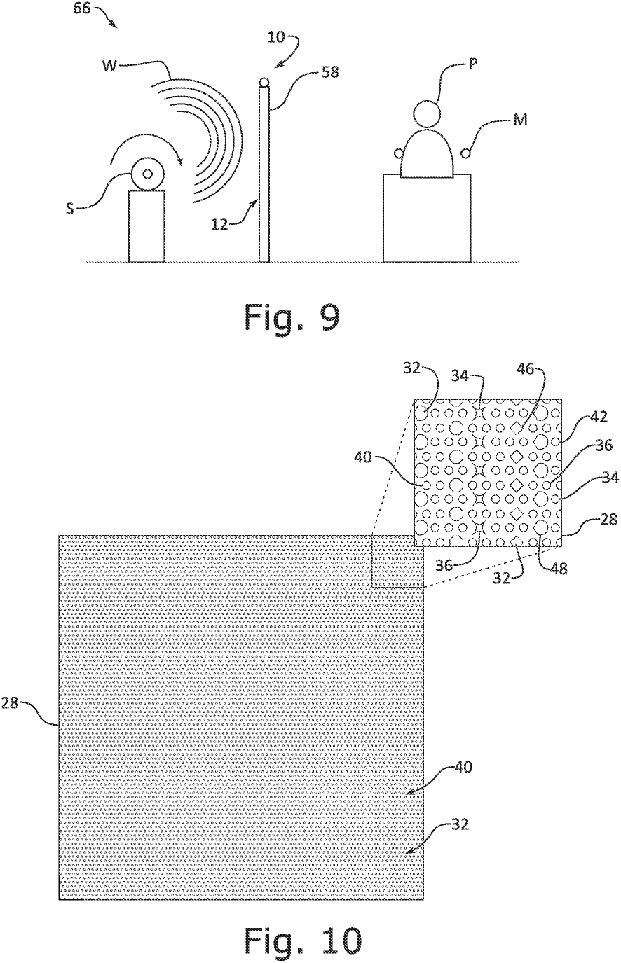

An acoustic curtain system (10) has a curtain (58) fashioned from an acoustic material system (12), in which the acoustic material system (12) has a matrix of material (14) that supports a plurality of evenly spaced wave scattering elements (16) and non-evenly spaced wave scattering elements (18) of different density. FIG. 9 is a diagram depicting an experimental set up (66) to measure the noise reduction of such an acoustic curtain system (10) fashioned with an acoustic material system (12). A noise source (S), and a person (p) and microphone (m) are depicted.

The curtain (58) may employ a concertina folding deployment arrangement as is well known in the art of curtains. A locking system (not shown) may hold the unfolded curtain (58) in place, and may include magnets. The curtain (58) may alternatively be suspended by hooks at the top attached to a holding rail or rod as is well known in the art of curtains. These acoustic curtain systems (10) have a range of industrial applications including but not limited to bunks, automobiles, aircraft, RV’s, boats, hospitals, doctor’s offices, bedrooms, factory working areas and gymnasiums.

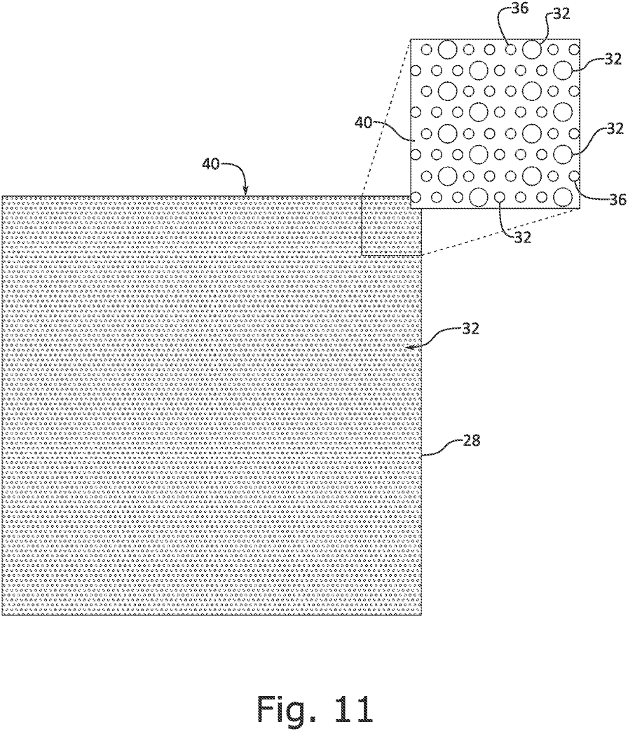

FIGS. 10 and 11 are top (plan) views of a microporous thin sheets (28) demonstrating alternative periodic or randomized non-periodic hole patterns (40). FIGS. 10 and 11 show corner blow ups, demonstrating alternative microporous sheet (28) hole (32) design patterns (40) and random distribution according to exemplary embodiments. Specifically, thin sheets (28) with micro holes (32) of different shapes (34) and sizes (36) and thickness (38) are shown in FIG. 11.

An acoustic treatment (11) comprising an acoustic material system (10) for a range of industrial applications including but not limited to bunks, automobiles, aircraft, RV’s, boats, hospitals; the acoustic material system (12) having a matrix of material (14) supporting a plurality of evenly spaced wave scattering elements (16) and non-evenly spaced wave scattering elements (18) of different density. The acoustic material system (12) for a range of industrial applications including but not limited to bunks, automobiles, aircraft, RV’s, boats, hospitals. an acoustic curtain system (10) for a range of industrial applications including but not limited to bunks, automobiles, aircraft, RV’s, boats, hospitals, doctor’s offices, bedrooms, factory working areas and gymnasiums.

A product fashioned by the acoustic curtain system (10) with the acoustic material system (12) is currently being used by a major HVAC company supporting the design and fabrication of quiet kits for their residential and commercial markets as well as other industries including military, fire rescue, hospital, automotive, and aerospace. Most recently, the acoustic curtain system (10) with the acoustic material system (12) was pilot tested as a prototype noise reduction system to quiet submarine bunk crew quarters in an operational environment onboard a Naval vessel.

It is to be understood that the present invention is not limited to the embodiments described earlier in this document, but encompasses any and all embodiments within the scope of the following claims.

What is claimed is:

1. An acoustic material system (12) comprising:
a matrix of material (14) supporting a plurality of evenly spaced wave scattering elements (16) and non-evenly spaced wave scattering elements (18) of any size, shape, weight, and material.

2. The acoustic material system (12) of claim 1, wherein:
the matrix of material (14) supporting a plurality of evenly spaced wave scattering elements (16) and non-evenly spaced wave scattering elements (18) of different density.

3. The acoustic material system (12) of claim 1, wherein:
the matrix of material (14) consists of poroelastic material (20).

4. The acoustic material system (12) of claim 1, wherein:
the wave scatterer elements (16 and 18) consist of masses (22) of different shapes (24) and sizes (26).

5. The acoustic material system (12) of claim 1, wherein:
the wave scatterer elements (16 and 18) consist of thin sheets (28) of various polymer and metal materials (30).

6. The acoustic material system (12) of claim 5, wherein:
the various polymer and metal materials (30) are taken from the group comprising metalized microporous sheets (28), carbon fiber microporous sheets (28), fiberglass microporous sheets (28), polycarbonate sheets (28), and combinations thereof.

7. The acoustic material system (12) of claim 5, wherein:
the sheet (28) can be flat, Non-Flat, spherical, or section only or combinations thereof.

8. The acoustic material system (12) of claim 1, wherein:
the wave scatterer elements (16 and 18) consist of thin sheets (28) with micro holes (32) of different shapes (34) and sizes (36) and thickness (38).

9. The acoustic material system (12) of claim 8, wherein:
the micro holes (32) are in a randomized non-periodic hole pattern (40) and hole size (36).

10. The acoustic material system (12) of claim 8, wherein:
the hole shape (34) may be any circular (42), elliptical (44), rectangular (46), polyhedral (48), volcano punch (conical) (50) shape, or essentially randomized combinations thereof.

11. The acoustic material system (12) of claim 1, wherein:
the wave scatterer elements (16 and 18) consist of voids (52) in the matrix material (14) of different shapes and sizes including spheres (54) and thin surfaces (56).

12. The acoustic material system (12) of claim 4, wherein the masses (22) of different shapes (24) and sizes (26) include Helmholtz resonators (58).

13. The acoustic material system (12) of claim 3, wherein:
the wave scatterer elements (16 and 18) consist of masses (22) of different shapes (24) and sizes (26).

14. The acoustic material system (12) of claim 11, wherein:
the wave scatterer elements (16 and 18) consist of thin sheets (28) of various polymer and metal materials (30).

15. The acoustic material system (12) of claim 14, wherein:
the wave scatterer elements (16 and 18) consist of thin sheets (28) with micro holes (32) of different shapes (34) and sizes (36) and thickness (38).

16. The acoustic material system (12) of claim 15, wherein:
the wave scatterer elements (16 and 18) consist of voids (52) in the matrix material (14) of different shapes and sizes including spheres (54) and thin surfaces (56).

17. An acoustic curtain system (10) comprising:
a curtain (58) fashioned from an acoustic material system (12);
the acoustic material system (12) having a matrix of material (14) supporting a plurality of evenly spaced wave scattering elements (16) and non-evenly spaced wave scattering elements (18) of different density.

18. The acoustic curtain system (10) of claim 17, wherein
the curtain (58) employs a concertina folding deployment arrangement.

19. The acoustic curtain system (10) of claim 17, further comprising:
a locking system to hold the unfolded curtain (58) in place including magnets.

20. The acoustic curtain system (10) of claim 17, wherein
the curtain (58) is suspended by hooks at the top attached to a holding rail or rod.

21. An acoustic treatment (11) comprising:
an acoustic material system (12) for a range of industrial applications including but not limited to bunks, automobiles, aircraft, RV’s, boats, hospitals;
the acoustic material system (12) having a matrix of material (14) supporting a plurality of evenly spaced wave scattering elements (16) and non-evenly spaced wave scattering elements (18) of different density.

22. The acoustic treatment (11) according to claim 21, wherein:
the acoustic material system (12) for a range of industrial applications including but not limited to bunks, automobiles, aircraft, RV’s, boats, hospitals.

23. The acoustic treatment (11) according to claim 21, further comprising:
an acoustic curtain system (12) for a range of industrial applications including but not limited to bunks, automobiles, aircraft, RV’s, boats, hospitals, doctor’s offices, bedrooms, factory working areas and gymnasiums.
